(19) United States
(12) Patent Application Publication
(10) Pub. No.: US 2025/0173172 A1
(43) Pub. Date: May 29, 2025

(54) ADAPTIVE EVICTION OF IDLE VIRTUAL FUNCTIONS FOR MAXIMUM USAGE OF A PARALLEL PROCESSING UNIT

(71) Applicants: Advanced Micro Devices, Inc., Santa Clara, CA (US); ATI Technologies ULC, Markham (CA)

(72) Inventors: Peng Ju Zhou, Shanghai (CN); HaiJun Chang, Shanghai (CN); Yinan Jiang, Richmond Hill (CA); JinYun Liu, Shanghai (CN); XiaoJian Yang, Shanghai (CN)

(21) Appl. No.: 18/519,525

(22) Filed: Nov. 27, 2023

(51) Int. Cl. G06F 9/455

(52) U.S. Cl. CPC G06F 9/45558; G06F 2009/4557

(57) ABSTRACT

A device includes a parallel processor and a context switch scheduling circuit that is part of or separate from the parallel processor. The parallel processor is configured to execute requests from a plurality of virtual functions. The context switch scheduling circuit is configured to, responsive to a first virtual function of the plurality of virtual functions becoming idle during a first time slice at the parallel processor, perform a context switch for a second virtual function of the plurality of virtual functions before expiration of the first time slice, and assign a second time slice at the parallel processor to the second virtual function.

### BACKGROUND

Processing units, such as graphics processing units (GPUs), machine learning (ML) accelerators, and other parallel processors, support virtualization that allows multiple virtual machines to use the hardware resources of the processing unit. Each virtual machine executes as a separate process that uses the hardware resources of the processing unit. Some virtual machines implement an operating system that allows the virtual machine to emulate an actual machine. Other virtual machines are designed to execute code in a platform-independent environment. A hypervisor creates and runs the virtual machines, which are also referred to as guest machines or guests. The virtual environment implemented on the processing unit provides virtual functions to other virtual components implemented on a physical machine. A single physical function (PF) implemented in the processing unit is used to support one or more virtual functions (VFs). The single root input/output virtualization (SR-IOV) specification allows multiple virtual machines (VMs) to share a processing unit interface to a single bus, such as a peripheral component interconnect express (PCIe) bus. Components access the virtual functions by transmitting requests over the bus.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system in accordance with some implementations.

FIG. 2 is a block diagram illustrating an example configuration of the processing system of FIG. 1 for performing work-state-aware scheduling of virtual functions and adaptive eviction of virtual functions during executing time slices at a parallel processor in accordance with some implementations.

FIG. 3 is a flow diagram illustrating a method for performing work-state-aware scheduling and adaptive eviction of virtual functions at a parallel processor in accordance with some implementations.

### DETAILED DESCRIPTION

SR-IOV, when applied to parallel processor virtualization, provides a mechanism by which a parallel processor, such as a GPU, appears to be multiple separate devices. For example, when a parallel processor is first initialized, the parallel processor is divided into multiple virtual functions, which are virtual instances of the parallel processor that can be assigned to a different virtual machine. Each virtual machine appears as if the virtual machine has its own dedicated parallel processor. Using temporal partitioning, a physical function implemented by the parallel processor allocates the virtual functions to different virtual machines on a time-slice basis. A context switch occurs between each time slice, which involves the parallel processor saving the current processing state of the virtual function that is finishing its time slice, and then loading the saved state for the next virtual function that will be using the parallel processor.

Temporal partition-based SR-IOV solutions typically use a time-slice-based fairness mode to schedule virtual functions that share a parallel processor. In this scheduling mode, each virtual function is allocated a uniform or fixed time slice during which the virtual function has access to the parallel processor. That is, virtual functions sharing the parallel processor are configured identically with uniform time slices across all virtual functions. Although allocating uniform time slices identically across virtual functions provides fairness, simple cost management, and predictability of virtual function performance, identical allocations can lead to underutilization of the parallel processor in some circumstances. For example, if the currently running virtual function completes its job and becomes idle before the current time slice is exhausted, the parallel processor bandwidth is not fully used during that time slice. Also, each virtual function is typically allocated a uniform time slice irrespective of whether the virtual function is busy or idle. At the next time slice, a context switch is performed to serve the next virtual function even if that virtual function is idle, which wastes processor bandwidth since an idle virtual function does not utilize the parallel processor during its time slice.

Accordingly, the present disclosure describes implementations of systems and techniques for assigning time slices at a parallel processor of a host processing system to a virtual function based on the current work state (e.g., busy or idle) of the virtual function. As described in greater detail below, during a time slice assigned to a virtual function, a time slice monitor detects when the virtual function has completed its task prior to the time slice expiring. Stated differently, the time slice monitor detects that the parallel processor is idle (i.e., not being used by the virtual function) during an active time slice. The time slice monitor then initiates an adaptive eviction process for the idle virtual function. For example, the time slice monitor notifies a context switch scheduler that the virtual function has completed its task(s) and that the parallel processor is available for another virtual function. In response to receiving this notification, the context switch scheduler performs a context switch and allocates/assigns a time slice to another virtual function instead of waiting for the current time slice to expire.

In some instances, the next virtual function selected for a time slice allocation may be idle; that is, the virtual function does not have work to be performed by the parallel processor. If the context switch scheduler assigns a time slice to an idle virtual function, the processor bandwidth for that time slice is wasted. Therefore, in at least some implementations, a work state monitor records the current work state (e.g., busy or idle) of one or more active (i.e., initialized) virtual functions. When the context switch scheduler receives a notification from the time slice monitor that a virtual function assigned to the currently active time slice has completed its task(s), or upon expiration of the currently active time slice, the context switch scheduler checks the current work state of the next virtual function. If the context switch scheduler determines that the next virtual function is busy (i.e., has work to be performed by the parallel processor), the context switch scheduler assigns a time slice to this virtual function. However, if the context switch scheduler determines that the next virtual function is idle (i.e., does not have work to be performed by the parallel processor), the context switch scheduler does not assign a time slice to this virtual function. Instead, the context switch scheduler identifies the next virtual function that has work to be performed by the parallel processor and assigns the next time slice to this virtual function. As such, the systems and techniques described herein maximize parallel processor usage in temporal partition-based SR-IOV environments by adaptively evicting idle virtual functions from an active time slice and assigning time slices only to virtual functions that have pending work for the parallel processor.

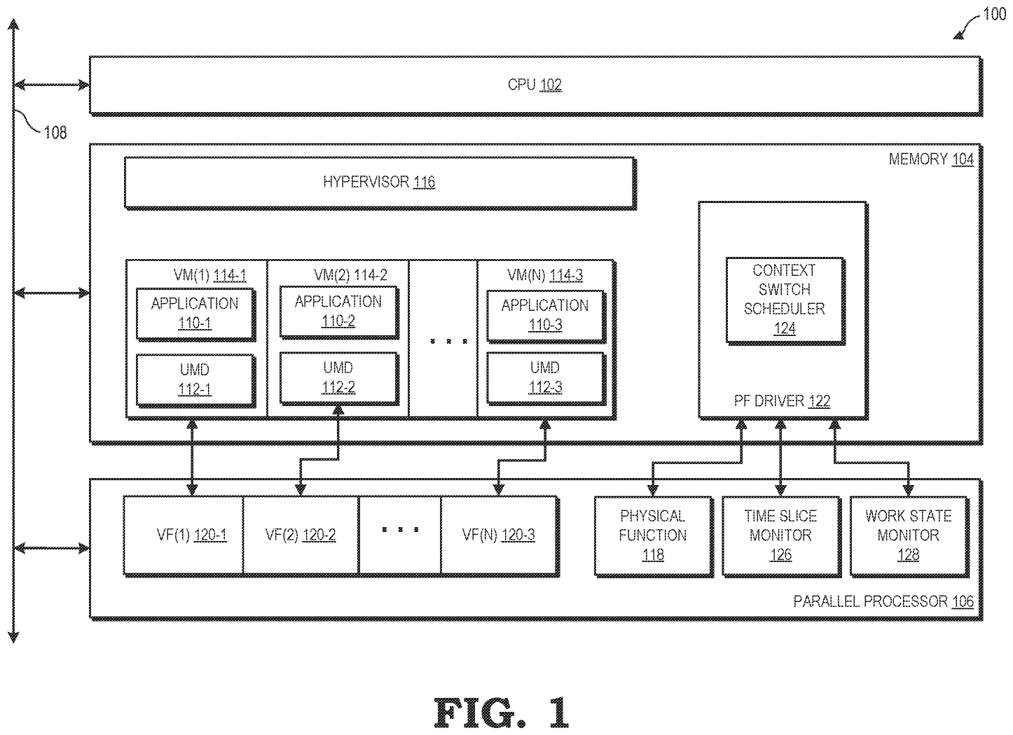

FIG. 1 is a block diagram of a processing system 100 configured to adaptively assign time slices at a parallel processor to virtual functions based on a work state of each virtual function in accordance with some implementations. The processing system 100 includes a central processing unit (CPU) 102 for executing instructions such as draw calls and a parallel processor 106, such as a GPU, ML accelerator, and the like, for performing graphics processing and, in some implementations, general-purpose computing. The processing system 100 also includes a memory 104 such as a system memory, which is implemented as dynamic random access memory (DRAM), static random access memory (SRAM), nonvolatile RAM, or other type of memory. The CPU 102, the parallel processor 106, and the memory 104 communicate over an interface 108 that is implemented using a bus such as a peripheral component interconnect (PCI, PCI-E) bus. However, other implementations of the interface 108 are implemented using one or more of a bridge, a switch, a router, a trace, a wire, or a combination thereof, or the like. The processing system 100 is implemented in devices such as a computer, a server, a laptop, a tablet, a smartphone, and the like.

The CPU 102 executes processes such as one or more applications 110 (illustrated as application 110-1 to application 110-3) that generate commands, a user mode driver (UMD) 112 (illustrated as UMD 112-1 to UMD 112-3), and other drivers. The applications 110 include applications that utilize the functionality of the parallel processor 106, such as applications that generate work in the processing system 100 or an operating system (OS). Some implementations of the applications 110 generate commands that are provided to the parallel processor 106 over the interface 108 for execution. For example, the applications 110 can generate commands that are executed by the parallel processor 106 to render a graphical user interface (GUI), a graphics scene, or an image or combination of images for presentation to a user.

Some implementations of the applications 110 utilize an application programming interface (API) (not shown) to invoke the user mode driver 112 to generate the commands that are provided to the parallel processor 106. In response to instructions from the API, the user mode driver 112 issues one or more commands to the parallel processor 106, e.g., in a command stream or command buffer. The parallel processor 106 executes the commands provided by the API to perform operations such as rendering graphics primitives into displayable graphics images. Based on the graphics instructions issued by applications 110 to the user mode driver 112, the user mode driver 112 formulates one or more graphics commands that specify one or more operations for the parallel processor 106 to perform for rendering graphics. In some implementations, the applications 110 each have a process that has an instance of the user mode driver 112 that communicates with the guest OS and kernel mode driver to utilize the parallel processor 106.

The processing system 100 comprises multiple virtual machines (VMs) 114 (illustrated as VM(1) 114-1 to VM(N) 114-3) that are configured in memory 104 on the processing system 100. Resources from physical devices of the processing system 100 are shared with the VMs 114. The resources can include, for example, a graphics processor resource from the parallel processor 106, a central processing unit resource from the CPU 102, a memory resource from memory 104, a network interface resource from a network interface controller, or the like. The VMs 114 use the resources for performing operations on various data (e.g., video data, image data, textual data, audio data, display data, peripheral device data, etc.). In at least some implementations, the processing system 100 includes a plurality of resources, which are allocated and shared amongst the VMs 114.

The processing system 100 also includes a hypervisor 116 that is represented by executable software instructions stored in memory 104 and manages instances of VMs 114. The hypervisor 116 is also known as a virtualization manager or virtual machine manager (VMM). The hypervisor 116 controls interactions between the VMs 114 and the various physical hardware devices, such as the parallel processor 106. The hypervisor 116 includes software components for managing hardware resources and software components for virtualizing or emulating physical devices to provide virtual devices, such as virtual disks, virtual processors, virtual network interfaces, or a virtual parallel processor as further described herein for each virtual machine 114. In at least some implementations, each virtual machine 114 is an abstraction of a physical computer system and may include an operating system (OS), such as Microsoft Windows® and applications, which are referred to as the guest OS and guest applications, respectively, wherein the term “guest” indicates it is a software entity that resides within the VMs 114.

The VMs 114 generally are instanced, meaning that a separate instance is created for each of the VMs 114. It should be understood that a host system may support any number N of virtual machines. As illustrated, the hypervisor 116 provides N virtual machines 114, with each of the virtual machines 114 providing a virtual environment wherein guest system software resides and operates. The guest system software includes applications 110 and VM kernel mode drivers (KMDs) (not shown) typically under the control of a guest OS. The VM KMDs control operation of the parallel processor 106 by, for example, providing an API to software (e.g., applications 110) executing on the CPU 102 to access various functions of the parallel processor 106. In some implementations, the processing system 100 comprises containers instead of, or in addition to, the VMs 114. In at least some of these implementations, the processing system 100 also comprises a container manager instead of, or in addition to, the hypervisor 116.

In various virtualization environments, single-root input/output virtualization (SR-IOV) specifications allow for a single Peripheral Component Interconnect Express (PCIe) device (e.g., the parallel processor 106) to appear as multiple separate PCIe devices. A physical PCIe device (such as the parallel processor 106) having SR-IOV capabilities, in at least some implementations, is configured to appear as multiple functions. The term “function” as used herein refers to a device with access controlled by a PCIe bus. SR-IOV operates using the concepts of physical functions (PF) and virtual functions (VFs), where physical functions are full-featured functions associated with the PCIe device. A virtual function (VF) is a function on a PCIe device that supports SR-IOV. The VF is associated with the PF and represents a virtualized instance of the PCIe device. Each VF has its own PCI configuration space. Further, each VF also shares one or more physical resources on the PCIe device with the PF and other VFs.

In the example implementation of FIG. 1, SR-IOV specifications enable the sharing of the parallel processor 106 among the virtual machines 114. The parallel processor 106, in at least some implementations, is a PCIe device having a physical function 118 and is divided into multiple VFs (illustrated as VF(1) 120-1 to VF(N) 120-3). The VFs 120 are derived from the physical function 118 of the parallel processor 106, thereby mapping a single physical device (e.g., the parallel processor 106) to a plurality of VFs 120 that is shared with the guest VMs 114. In at least some implementations, the hypervisor 116 maps (e.g., assigns) the VFs 120 to the guest virtual machines 114. In at least some implementations, the hypervisor 116 delegates the assignment of VFs 120 to a physical function (PF) driver 122 (also referred to as a host physical driver) of the parallel processor 106. For example, VF(1) 120-1 is mapped to VM(1) 114-1, VF(2) 120-2 is mapped to VM(2) 114-2, and so forth. The VFs 120 appear to the OS of their respective VM 114 in the same manner as a physical parallel processor would appear to an operating system, and thus, the VMs 114 use the VFs 120 as though they were a hardware device. In at least some implementations, the PF driver 122 is implemented at the hypervisor 116. However, in other implementations, the PF driver 122 is implemented at the host kernel space or host user mode space (not shown). If the processing system 100 implements containers and a container manager, the VM KMDs are configured to run in the same spaces as the PF driver 122.

In at least some implementations, initialization of a VF 120 involves configuring hardware registers of the parallel processor 106. The hardware registers (not shown) store hardware configuration data for the parallel processor 106. A full set of hardware registers is accessible to the physical function 118. The hardware registers are shared among multiple VFs 120 by using context save and restore to switch between and run each virtual function. Therefore, exclusive access to the hardware registers is required for the initializing of new VFs. As used herein, “exclusive access” refers to the parallel processor 106 registers being accessible by only one VF at a time during the initialization of VFs. When a VF is being initialized, all other virtual functions are paused or otherwise put in a suspended state where the virtual functions and their associated virtual machines do not consume parallel processor 106 resources. When paused or suspended, the current state and context of the VF/VM are saved to a memory location. In at least some implementations, exclusive access to the hardware registers allows a new virtual function to begin initialization by pausing other running functions. After creation, the VF 120 is able to be directly assigned an I/O domain. The hypervisor 116 assigns a VF 120 to a corresponding VM 114 by mapping configuration space registers of the VFs 120 to the configuration space presented to the VM by the hypervisor 116. This capability enables the VF 120 to share the parallel processor 106 and to perform I/O operations without CPU 102 and hypervisor 116 software overhead.

In at least some implementations, after a new VF 120 finishes initializing, a context switch scheduling circuit 124 (also referred to herein as “context switch scheduler) triggers context switches between all already active VFs 120 that have already finished initialization such that each VF 120 is allocated a time slice on the parallel processor 106 to handle any accumulated commands. In operation, the context switch scheduler 124, in at least some implementations, manages time slices for the VFs 120 that share the parallel processor 106. That is, the context switch scheduler 124 is configured to manage time slices by tracking the time slices, stopping work on the parallel processor 106 when a time slice for a VF 120 that is being executed has expired, and starting work for the next VF 120 having the subsequent time slice. Although the context switch scheduler 124 is illustrated as part of the PF driver 122, in other implementations, the context switch scheduler 124 is separate from the PF driver 122. Also, the context switch scheduler 124 is implemented as hardware, circuitry, firmware or a firmware-controlled microcontroller running in the parallel processor 106, software, or any combination thereof

In conventional temporal partition-based SR-IOV environments, identical fixed time slices are typically assigned to each VF. Therefore, a context switch generally does not occur until the current time slice has expired even if the VF completes its work prior to the time slice expiring, which wastes bandwidth of the parallel processor 106 for the remaining portion of the time slice. Also, the time slices are typically assigned to each VF irrespective of whether the VF is busy (i.e., has pending work for the parallel processor 106) or idle (i.e., does not have pending work for the parallel processor 106). Therefore, when a context switch is performed and an idle VF is assigned the next time slice, the idle VF does not utilize the parallel processor 106 and the entire time slice is wasted.

Therefore, to maximize usage of the parallel processor 106 and to more efficiently allocate time slices to the VFs 120, the context switch scheduler 124 is configured to adaptively evict an idle VF 120 during the current time slice and perform work-state-aware scheduling of VFs 120. In at least some implementations, adaptive eviction of an idle VF 120 includes the context switch scheduler 124 detecting when a VF 120 becomes idle during its assigned time slice. Stated differently, the context switch scheduler 124 detects when the VF 120 completes its work such that the VF 120 is no longer utilizing the parallel processor 106 during the time slice. The context switch scheduler 124 performs a context switch to service another VF 120 and assigns this VF 120 the next time slice in response to determining that the VF 120 has become idle during the current time slice instead of waiting until the time slice expires. As such, the adaptive eviction process performed by the context switch scheduler 124 provides for the context switch and time slice assignment for the next VF 120 to occur earlier than conventional VF scheduling techniques that wait for the current time slice to expire, thereby increasing utilization of the parallel processor 106.

The context switch scheduler 124, in at least some implementations, performs work-state-aware scheduling of VFs 120 in response to any situation or event requiring a time slice to be assigned to a VF 120. Examples of these situations/events include assigning the first time slice to the first VF 120, a current time slice expiring, the adaptive eviction process described above, and the like. In at least some implementations, work-state-aware scheduling of VFs 120 includes the context switch scheduler 124 detecting the current work state (e.g., busy work state or idle work state) of a VF 120 under consideration for scheduling and selectively assigning or not assigning a time slice to the VF 120 based on the detect work state. For example, the context switch scheduler 124 determines if the VF 120 has pending work (e.g., busy work state) for the parallel processor 106 or has no pending work (e.g., idle work state) for the parallel processor 106. If the context switch scheduler 124 detects that the VF 120 under consideration has a busy work state, the context switch scheduler 124 performs a context switch and assigns this VF 120 the next time slice. However, if the context switch scheduler 124 detects that the VF 120 has an idle work state, the context switch scheduler 124 does not perform a context switch for or assign the next time slice to this VF 120. Stated differently, the context switch scheduler 124 skips a VM(s) 114 with an idle work state and selects a VF 120 with a busy work state for scheduling (e.g., performing a context switch and assignment of the next time slice). As such, the work-state-aware VF scheduling process performed by the context switch scheduler 124 provides for increased utilization of the parallel processor 106 by only scheduling VFs 120 with a busy work state such that VFs 120 with an idle work state do not waste time slices and parallel processor bandwidth.

To facilitate the adaptive VF eviction and the VF work-state-aware scheduling techniques employed by the context switch scheduler 124, the processing system 100, in at least some implementations, further includes a time slice monitoring circuit 126 (also referred to herein as “time slice monitor 126”) and a VF work state monitoring circuit 128 (also referred to herein as “work state monitor 128”). The time slice monitor 126 determines when the VF 120 assigned to the current time slice has completed its work and has become idle. In at least some implementations, the time slice monitor 126 notifies the context switch scheduler 124 that the VF 120 has become idle during the current time slice, which triggers the context switch scheduler 124 to perform the adaptive VF eviction process described above. The VF work state monitor 128 maintains the current work state (e.g., busy work state or idle work state) of each of VF 120 available for scheduling and provides work state information to the context switch scheduler 124. The context switch scheduler 124 uses the work state information provided by the VF work state monitor 128 to perform the VF work-state-aware scheduling process described above. It should be understood that although the time slice monitor 126 and the VF work state monitor 128 are shown in FIG. 1 as part of the parallel processor 106, in at least some implementations, one or more of these components are separate from the parallel processor 106. For example, in some implementations, one or more of the time slice monitor 126 or the VF work state monitor 128 are part of the context switch scheduler 124 or are standalone components of the processing system 100. The time slice monitor 126 and the VF work state monitor 128 are implemented as hardware, circuitry, firmware, a firmware-controlled microcontroller, software, or any combination thereof.

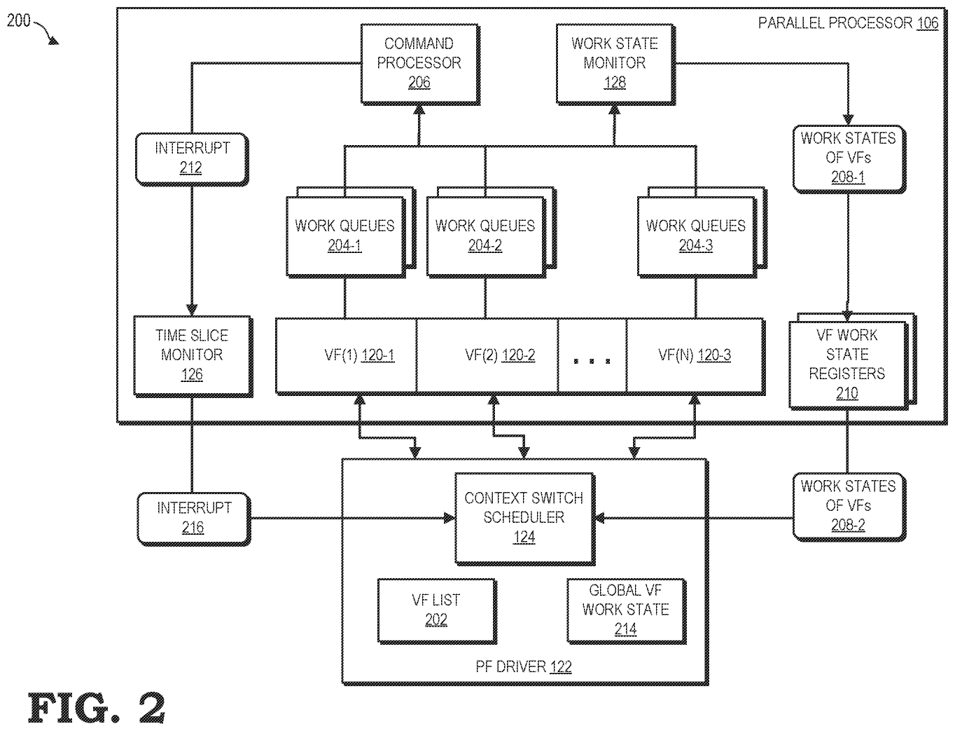

FIG. 2 is a block diagram 200 illustrating an example configuration of the processing system 100 for implementing the adaptive VF eviction and the VF work-state-aware scheduling techniques described herein. In the illustrated example, the PF driver 122 initializes a plurality of VFs 120 and maintains a list 202 of these active VFs 120. As described above with respect to FIG. 1, each of the VFs 120 is mapped to a VM 114 (not shown in FIG. 2 for brevity). Applications 110 executing at the VMs 114 place work into one or more work queues 204 (illustrated as work queue 204-1 to work queue 204-3) associated with the VFs 120. For example, in at least some implementations, each VF 120 is associated with a graphics work queue for graphics commands, a compute work queue for compute commands, a secure or system Direct Memory Access (SDMA) queue for various data movement tasks, and the like. In at least some implementations, a command processor 206 is responsible for fetching work (e.g., commands) from the work queues 204 of the active VFs 120, decoding the fetched commands, and dispatching the work to one or more execution units (not shown) of the parallel processor 106.

In at least some implementations, the work state monitor 128 monitors the work queues 204 to determine the current work state 208 (illustrated as work state 208-1) of each VF 120. For example, the work state monitor 128 directly monitors the work queues 204 to determine if any of the queues 204 have pending work for the parallel processor 106. In another example, the work state monitor 128 monitors the work queues 204 through doorbells associated with the work queues 204. A doorbell is a notification mechanism that indicates when work is placed into a work queue 204. In at least some implementations, the work state monitor 128 detects a doorbell when a device driver or application writes to a doorbell register (not shown) associated with a work queue 204 and changes the value of the doorbell register. It should be understood that the work state monitor 128 can also implement other techniques for determining the current work state 208 of each VF 120. Also, in at least some implementations, the work state monitor 128 determines the current work state 208 of each VF 120 in real-time. However, in other implementations, the work state monitor 128 determines the current work state 208 of each VF 120 during scheduled monitoring periods.

Based on monitoring the work queues 204, the work state monitor 128 records/stores the current work state of a VF(s) 120 in one or more data structures or registers 210 (also referred to herein as a “VF work state register 210”). For example, in at least some implementations, the work state monitor 128 maintains a register 210, such as a bit-map register, for each type of work queue 204 (e.g., a graphics work queue, a compute work queue, and an SDMA work queue). Each bit in each register represents a VF 120. In some implementations, a single data structure or register 210 is maintained for all the work queues 204 associated with a VF 120. In other implementations, a single VF work state register is populated with VF work state data for multiple (or all) VFs 120 based on the work state data accumulated in each of the registers 210 associated with each of the VFs 120. When the work state monitor 128 determines that a VF 120 has pending work for the parallel processor, the work state monitor 128 changes (or maintains) the value of the bit representing the VF 120 in the corresponding register 210 to indicate that the VF 120 is in a busy work state. For example, if the current bit value for the VF 120 indicates an idle work state, the work state monitor 128 changes the bit value to indicate a busy state. However, if the bit value for the VF 120 currently indicates a busy state, the work state monitor 128 maintains (i.e., does not change) the current bit value. A similar process is performed when the work state monitor 128 determines that a VF 120 does not have pending work for the parallel processor 106. For example, if the work state monitor 128 detects that all of the work queues 204 associated with a VF 120 are currently empty or that a doorbell associated with the work queues 204 of the VF 120 has not been detected, the work state monitor 128 determines that the VF 120 is in an idle work state. The work state monitor 128 changes (or maintains) the value of the bit representing the VF 120 in the corresponding register 210 to indicate that the VF 120 is in an idle work state. For example, if the current bit value for the VF 120 indicates a busy state, the work state monitor 128 changes the bit value to indicate an idle work state. However, if the bit value for the VF 120 currently indicates an idle work state, the work state monitor 128 maintains (i.e., does not change) the current bit value.

In some instances, a time slice expires before the VF 120 is able to complete its work. For example, when a time slice starts, the context switch scheduler 124 initiates a timer. When the timer expires, the context switch scheduler 124 performs a context switch even if the VF work has not been completed. As such, in these situations, the VF 120 still has work and should be assigned a subsequent time slice. Therefore, in at least some implementations, a data structure or register 210 maintains a timed-out state for one or more VFs 120. For example, if a time slice expires before the VF 120 completes its work, the work state monitor 128, the context switch scheduler 124, or another component of the processing system 100 detects this condition and changes or maintains a bit value in the register 210 to indicate a timed-out state. The timed-out state indicates that the VF 120 did not complete its work during the previous time slice and should be assigned another time slice. Stated differently, the timed-out state indicates that the VF 120 is in a busy work state. In at least some implementations, a separate register 210 is maintained for VF timed-out states. However, in other implementations, when a timed-out state is detected for a VF 120, the work state monitor 128, or another component, sets (or maintains) the bit representing the VF 120 in the VF work state register 210 to indicate a busy work state.

The context switch scheduler 124 performs a VF scheduling process based on the current work state 208 (illustrated as work state 208-2) of the VFs 120 maintained in one or more registers 210. The VF scheduling process includes performing a context switch for a selected target VF 120 and assigning a time slice to the selected VF 120. For example, when the context switch scheduler 124 detects a scheduling event, the context switch scheduler 124 selects a VF 120 from the VF list 202 Examples of a scheduling event include the initialization of the VFs 120, the expiration of a current time slice, an adaptive VF eviction condition (e.g., a VF 120 completes its work prior to its assigned time slice expiring), and the like. The context switch scheduler 124, in at least some implements, selects a VF 120 from the VF list 202 using one or more techniques. In one example, the context switch scheduler 124 selects VFs 120 in a round-robin fashion or in a sequential manner. In another example, the context switch scheduler 124 randomly selects the VFs 120. In a further example, the context switch scheduler 124 selects VFs 120 based on a priority assigned to the VFs 120 or the work associated with the VFs 120. In at least some implementations, the context switch scheduler 124 employs one or more indexing techniques when iterating the VF list 202. For example, an index, in at least some implementations, identifies the VF 120 in the VF list 202 that is assigned to the current (or previous) time slice. In this example, when the context switch scheduler 124 iterates through the VF list 202 to select a target VF 120 for scheduling, the context switch scheduler 124 starts at the VF 120 after the VF 120 assigned to the current (or previous) time slice.

After a VF 120 has been selected from the VF list 202, the context switch scheduler 124 checks the registers 210 to determine the current work state 208 of the VF 120. If the work state 208 indicates that the selected VF 120 is in an idle work state, the context switch scheduler 124 skips the selected VF 120; that is, the context switch scheduler 124 does not perform a context switch or assign a time slice to the VF 120. The context switch scheduler 124 then selects another active VF 120 from the VF list 202 and checks its current work state 208. However, if the work state 208 indicates that the selected VF 120 is in a busy work state or a timed-out state, the context switch scheduler 124 schedules the VF 120 by performing a context switch for the selected VF 120 and assigning a time slice to the VF 120. The VF 120 then proceeds to utilize the parallel processor 106 to perform one or more tasks during the assigned time slice. In at least some implementations, instead of first selecting a VF 120 from the VF list 202 and then checking the current work state 208 of the VF 120, the context switch scheduler 124 first checks the VF work states in the register(s) 210 and then selects a VF 120 only if that VF 120 is associated with a busy work state.

In at least some implementations, if the context switch scheduler 124 determines that all VFs 120 in the VF list 202 are in an idle work state, the context switch scheduler 124 schedules each of the VFs 120 on a one-by-one basis in a sequential manner. Scheduling the idle VFs 120 ensures that a short unexpected/random job submitted during the time slice assigned to an idle VF 120 is able to be satisfied. Also, in at least some implementations the context switch scheduler 124 (or another component) maintains a global VF work state data structure or register 214 that indicates if any VF 120 in the VF list 202 has a busy work state or if all VFs 120 are in an idle work state. For example, when a determination is made that at least one VF 120 is in an idle state, a value in the global VF work state register 214 is set (or maintained) to indicate a global busy work state. However, if all VFs 120 are determined to be in an idle work state, a value in the global VF work state register 214 is set (or maintained) to indicate a global idle work state. In at least some implementations, the context switch scheduler 124 first checks the global VF work state register 214 to determine if any VF 120 has a busy state. If so, the context switch scheduler 124 then proceeds to check the registers 210 to select and schedule a VF 120 that is in a busy work state. However, if the global VF work state register 214 indicates that all VFs 120 are in an idle work state, the context switch scheduler 124 does not check the registers 210 but, instead, performs the one-by-one scheduling process described above.

After a VF 120 has been scheduled and the time slice initiated, the time slice monitor 126 detects when the VF 120 becomes idle before the time slice expires; that is, the VF 120 completes its work before the time slice expires. For example, in at least some implementations, when the VF 120 completes its work such that each of its work queues 204 is empty, the command processor 206 sends a work-complete signal or interrupt 212 or another signal to the time slice monitor 126. The interrupt 212 indicates to the time slice monitor 126 that the VF 120 has completed its work. In other implementations, the command processor 206 does not send an interrupt 212 to the time slice monitor 126. Instead, the time slice monitor 126 directly determines when the VF 120 has completed its work by, for example, monitoring the work queues 204 of the VF 120. It should be understood that other techniques for determining when the VF 120 has completed its work are also applicable. For example, if the power consumption of the parallel processor 106 drops below a specified power threshold, a signal is sent to the time slice monitor 126, indicating that the parallel processor 106 and, thus, the VF 120 are idle. In another example, a graphics driver running on the VF 120 inserts a notification package at the end of a render command. When the render frame is completed, the notification package generates an interrupt to the time slice monitor 126 or directly to the context switch scheduler 124. This interrupt indicates that the parallel processor 106 will not be used until the next frame. As such, the time slice monitor 126 is able to determine that the VF 120 is idle during a current slice based on receiving an interrupt 212 from the command processor 206, receiving an interrupt or signal from another component of the parallel processor 106, directly detecting an idle state of the VF 120, or the like. It should be understood that, in at least some implementations, the time slice monitor 126 and its functions described herein are implemented by the context switch scheduler 124.

In response to detecting that the VF 120 is idle during the current time slice, the time slice monitor 126 notifies the context switch scheduler 124 that the VF 120 assigned to the current time slice has become idle before the time slice has expired. For example, the time slice monitor 126 sends a context switch interrupt 216 or another signal to the context switch scheduler 124, indicating the idle state of the VF 120. In response to the context switch interrupt 216, the context switch scheduler 124 determines that an adaptive VF eviction condition exists and schedules the next VF 120 with a busy work state without waiting for the current time slice to expire. For example, the context switch scheduler 124 performs a context switch to save the current processing state of the VF 120 associated with the current time slice and load the saved state (if any) for the next VF 120 that will be using the parallel processor 106. The context switch scheduler 124 also assigns a time slice to the next VF 120 with a busy work state. The next VF 120 is selected by the context switch scheduler 124 based on the VF scheduling process described above.

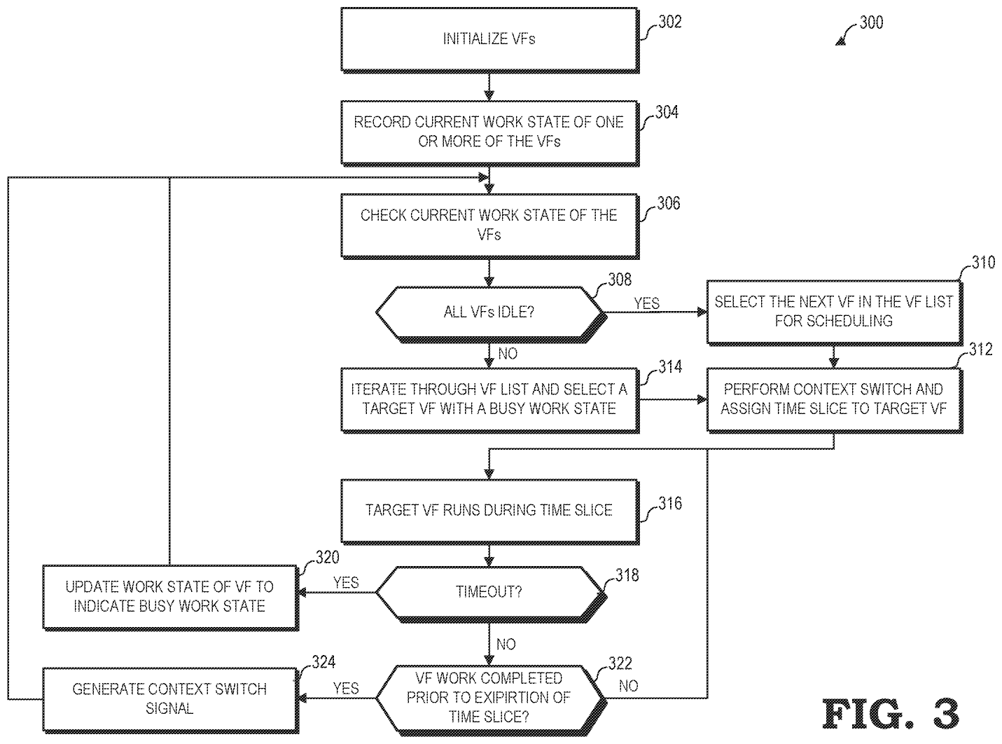

FIG. 3 illustrates a flow diagram of a method 300 for performing one or more of the adaptive VF eviction and VF work-state-aware scheduling techniques described herein. It should be understood that the processes described below with respect to method 300 have been described above in greater detail with reference to FIG. 1 and FIG. 2. For purposes of description, the method 300 is described with respect to an example implementation at the processing device of FIG. 1, but it will be appreciated that, in other implementations, the method 300 is implemented at processing devices having different configurations. Also, the method 300 is not limited to the sequence of operations shown in FIG. 3, as at least some of the operations can be performed in parallel or in a different sequence. Moreover, in at least some implementations, the method 300 can include one or more different operations than those shown in FIG. 3.

In at least some implementations, method 300 initiates at block 302 and the PF drive 122 initializes a plurality of VFs 120 and maintains a list 202 of these active VFs 120. At block 304, the work state monitor 128 records a current work state 208 (e.g., a busy work state or an idle work state) for one or more of the VFs 120. It should be understood that the work state monitor 128 is able to monitor and update the work state 208 of one or more VFs 120 throughout method 300.

At block 306, the context switch scheduler 124 initiates a VF work-state-aware scheduling process and checks the global VF work state register 214. At block 308, the context switch scheduler 124 determines if the global VF work state 214 indicates that all of the VFs 120 are in an idle work state. If all of the VFs 120 are in an idle work state, the context switch scheduler 124 performs the one-by-one scheduling process described above. For example, at block 310, the context switch scheduler 124 selects the next (or first) VF 120 from the VF list 120 and assigns the next (or first) time slice to this target VF 120. At block 312, the context switch scheduler 124 performs a context switch for the target VF 120 and assigns the next time slice to this VF 120. The process then flows to block 316. In configurations where the global VF work state register 214 is not implemented, the context switch scheduler 124 checks the VF work state registers 210 at block 306 to determine if all VFs 120 have an idle work state or if at least one VF has a busy work state.

Referring, back to block 308, if the global VF work state register 214 indicates that at least one VF 120 has a busy work state, the context switch scheduler 124, at block 314, iterates through the VF list 202 and selects a target VF 120 with a work busy state. For example, as the context switch scheduler 124 iterates through the VF list 202, it checks the VF work state register(s) 210 for each VF 120 in the VF list 202. If the VF work state register(s) 210 for the VF 120 under consideration indicates that the VF 120 has an idle work state, the context switch scheduler 124 skips this VF 120 and considers the next VF 120 in the list. However, if the VF work state register(s) 210 for the VF 120 under consideration indicates that the VF 120 has a busy work state, the context switch scheduler 124 selects this VF 120 as the target VF 120 and the process flows to block 312. In other words, the VF 120 is considered the next VF 120 to have a busy work state and is selected over the VFs 120 having an idle work state. At block 312, the context switch scheduler 124 performs a context switch for the target VF 120 and assigns the next time slice to this VF 120. The process then flows to block 316.

At block 316, the target VF 120 runs during the assigned time slice. At block 318, the time slice monitor 126 (or another component) determines if the time slice has expired before the target VF 120 was able to complete its work. If so, the work state monitor 128 (or another component), at block 320, updates (or maintains) the work state of the target VF 120 to indicate that the target VF 120 has a busy work state. The process then returns to block 306, and the context switch scheduler 124 performs the VF work-state-aware scheduling process for another VF 120. If the time slice is still running, the time slice monitor 126, at block 322, determines if the target VF 120 has completed its work before the time slice has expired. For example, the time slice monitor 126 determines if a work-complete interrupt 212 has been received from the command processor 206 or if the work queues 204 associated with the VF 120 are empty. If the time slice is still running and the target VF 120 has not completed its work, the process returns to block 318 and the time slice monitor 126 continues to monitor the time slice. If the target VF 120 has completed its work before the time slice has expired, the time slice monitor 126 generates and sends a context switch interrupt 216 (or another signal) to the context switch scheduler 124. The context switch interrupt 216 triggers the context switch scheduler 124 to immediately perform a context switch for the next VF 120 with a busy work state or at least without waiting for the current time slice to expire. For example, the process returns to block 306 so that the context switch scheduler 124 is able to identify the next VF 120, perform a context switch for the next VF 120, and assign a time slice to the next VF 120, as described above with respect to blocks 306 to 314. As such, utilization of the parallel processor 106 is increased by selectively assigning time slices to VFs 120 that have work and adapting the assigned time slices so that work-light VFs 120 have less parallel processor time and work-heavy VFs 120 have more parallel processor time.

In some implementations, certain aspects of the techniques described above may be implemented by one or more processors of a processing system executing software. The software includes one or more sets of executable instructions stored or otherwise tangibly implemented on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, volatile memory device or devices, non-volatile memory device or devices, microelectromechanical systems (MEMS)-based storage media, and the like. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)). The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method comprising:
responsive to a first virtual function becoming idle during a first time slice at a parallel processor:
performing a context switch for a second virtual function before expiration of the first time slice; and
assigning a second time slice at the parallel processor to the second virtual function.

2. The method of claim 1, further comprising:
determining that the first virtual function has become idle during the first time slice in response to at least one of:
a set of work queues associated with the first virtual function being empty;
receiving a work-complete signal from a component of the parallel processor; or
power consumption of the parallel processor dropping below a threshold.

3. The method of claim 1, further comprising:
selecting the second virtual function from a plurality of virtual functions based on a current work state associated with the second virtual function.

4. The method of claim 3, wherein selecting the second virtual function from the plurality of virtual functions is in response to the current work state indicating that the second virtual function has pending work for the parallel processor.

5. The method of claim 3, further comprising:
determining the current work state of the second virtual function from at least one register or data structure configured to indicate whether the second virtual function has work pending for the parallel processor or is without work pending for the parallel processor.

6. The method of claim 3, wherein selecting the second virtual function from the plurality of virtual functions comprises:
responsive to iterating through the plurality of virtual functions, determining that the second virtual function is a next virtual function of the plurality of virtual functions having pending work for the parallel processor.

7. The method of claim 3, wherein selecting the second virtual function from the plurality of virtual functions comprises:
responsive to at least a third virtual function of the plurality of virtual functions being without pending work for the parallel processor, determining if the second virtual function has pending work for the parallel processor; and
responsive to the second virtual function having pending work for the parallel processor, selecting the second virtual function over the at least third virtual function.

8. A device comprising:
a parallel processor configured to execute requests from a plurality of virtual functions; and
a context switch scheduling circuit that is part of or separate from the parallel processor, the context switch scheduling circuit configured to, responsive to a first virtual function of the plurality of virtual functions becoming idle during a first time slice at the parallel processor:
perform a context switch for a second virtual function of the plurality of virtual functions before expiration of the first time slice; and
assigning a second time slice at the parallel processor to the second virtual function.

9. The device of claim 8, wherein the context switch scheduling circuit is configured to determine that the first virtual function has become idle during the first time slice in response to at least one of:
a set of work queues associated with the first virtual function being empty;
receiving a work-complete signal from the parallel processor; or
power consumption of the parallel processor dropping below a threshold.

10. The device of claim 8, wherein context switch scheduling circuit is further configured to select the second virtual function from the plurality of virtual functions based on a current work state associated with the second virtual function.

11. The device of claim 10, wherein the context switch scheduling circuit is configured to select the second virtual function from the plurality of virtual functions in response to the current work state indicating that the second virtual function has pending work for the parallel processor.

12. The device of claim 10, wherein the context switch scheduling circuit is configured to determine the current work state of the second virtual function from at least one register or data structure configured to indicate whether the second virtual function has work pending for the parallel processor or is without work pending for the parallel processor.

13. The device of claim 10, wherein the context switch scheduling circuit is configured to select the second virtual function from the plurality of virtual functions by determining, in response to iterating through the plurality of virtual functions, that the second virtual function is a next virtual function of the plurality of virtual functions having pending work for the parallel processor.

14. The device of claim 10, wherein the context switch scheduling circuit is configured to select the second virtual function from the plurality of virtual functions by:
responsive to at least a third virtual function of the plurality of virtual functions being without pending work for the parallel processor, determining if the second virtual function has pending work for the parallel processor; and
responsive to the second virtual function having pending work for the parallel processor, selecting the second virtual function over the at least third virtual function.

15. A device comprising:
a parallel processor configured to execute requests from a plurality of virtual functions;
a work state monitoring circuit that is part of or separate from the parallel processor, the work state monitoring circuit configured to maintain a current work state of each virtual function of the plurality of virtual functions;
a context switch scheduling circuit that is part of or separate from the parallel processor, the context scheduling circuit configured to selectively assign a first time slice to a first virtual function of the plurality of virtual functions based on the current work state associated with the first virtual function; and
a time slice monitoring circuit that is part of or separate from the parallel processor, the time slice monitoring circuit configured to signal the context switch scheduling circuit when a virtual function of the plurality of virtual functions becomes idle during a time slice assigned to the virtual function.

16. The device of claim 15, wherein the work state monitoring circuit is configured to maintain the current work state of each virtual function by at least one of:
monitoring a set of work queues associated with each virtual function; or
monitoring for doorbells associated with each work queue of the set of work queues associated with each of virtual function.

17. The device of claim 16, wherein the work state monitoring circuit is configured to at least one of:
set the current work state for a virtual function of the plurality of virtual functions to a busy work state in response to at least one of:
detecting that work has been placed in at least one work queue of the set of work queues associated with the virtual function, or
detecting a doorbell associated with at least one work queue of the set of work queues associated with the virtual function; or
set the current work state for the virtual function of the plurality of virtual functions to an idle work state in response to at least one of:
detecting that the set of work queues associated with the virtual function is empty, or
determining that a doorbell has not been detected for any of the work queues of the set of work queues associated with the virtual function.

18. The device of claim 15, wherein the time slice monitoring circuit is configured to signal the context switch scheduling circuit in response to a virtual function of the plurality of virtual functions becoming idle in response to at least one of:
receiving a work-complete signal from a command processor of the parallel processor; or
detecting that each work queue of a set of work queues associated with the virtual function is empty.

19. The device of claim 15, wherein the context switch scheduling circuit is further configured to selectively assign a second time slice to a second virtual function of the plurality of virtual functions prior to the first time slice expiring in response to receiving a signal from the time slice monitoring circuit indicating that the first virtual function has become idle before expiration of the first time slice.

20. The device of claim 19, wherein the context switch scheduling circuit is further configured to selectively assign the second time slice to the second virtual function by:
responsive to at least a third virtual function of the plurality of virtual functions being without pending work for the parallel processor, determining if the second virtual function has pending work for the parallel processor, and
responsive to the second virtual function having pending work for the parallel processor, selecting the second virtual function over the at least third virtual function.
